(19) United States
(12) Patent Application Publication
(10) Pub. No.: US 2008/0050556 A1
(43) Pub. Date: Feb. 28, 2008

(54) WOOD STRAND CEMENT BOARDS WITH A PRCTICALLY CLOSED SURFACE AND PRODUCTION PROCESS

(76) Inventor: Gerrit J. Van Elten, Voorthuizen (NL)

Correspondence Address: PEACOCK MYERS, P.C., 201 THIRD STREET, N.W., SUITE 1340, ALBUQUERQUE, NM, 87102, US

(21) Appl. No.: 11/928,566

(22) Filed: Oct. 30, 2007

Related U.S. Application Data
(63) Continuation of application No. 11/025,181, filed on Dec. 29, 2004.
Application No. 11/025,181 is a continuation of application No. PCT/NL03/00488, filed on Jul. 3, 2003.

(30) Foreign Application Priority Data
Jul. 3, 2002 (NL) NL 1020982

(51) Int. Cl. B32B 5/12; B29C 39/14; B29C 65/00

(52) U.S. Cl. 428/114; 156/39; 264/166

(57) ABSTRACT

A mineral bonded Wood Strand Cement (usually Portland cement or Magnesite or Gypsum) Board which is produced from a mixture of wood strands or a similar fibre material, water, a suitable binder like cement, and possibly additives, which mixture is cured under pressure to form a board with a practically entirely closed surface. For the boards according to the invention, wood strands are being used that are broader and thinner than used until presently in acoustic Wood Wool Cement Boards. Moreover, the invention relates to a method of orienting wood strands and a production process for the production of such Wood Strand Cement Boards.

### CROSS-REFERENCE TO RELATED APPLICATIONS

This application is a continuation-in-part application of U.S. patent application Ser. No. 11/025,181, entitled “Wood Strand Board”, to Gerrit Jan Van Elten, filed on Dec. 29, 2004, and the specification and claims thereof are incorporated herein by reference.

### BACKGROUND OF THE INVENTION

### Field of the Invention (Technical Field)

The present invention relates to a mineral bonded wood strand cement (usually Portland cement, magnesite or gypsum) board and to a method of orienting strands and a method for manufacturing a wood strand cement board.

### BRIEF SUMMARY OF THE INVENTION

The present invention relates to a mineral bonded wood strand cement (usually Portland cement, magnesite or gypsum) board, manufactured from a mixture consisting of: wood strands or a similar fiber material; a suitable binder like cement; and water with possibly additives; which mixture is cured to form a board with a practically entirely closed surface, wherein said wood strands have a width of at least 2 mm, more preferably at least 3 mm and most preferably at least 6 mm and a width of maximally 12 mm or more, more preferably maximally 10 mm, and a thickness of at least 0.15 mm and maximally 1.0 mm, preferably maximally 0.5 mm, and wherein the weight ratio of water to wood strands is maximally 1.25:1, preferably maximally 1.10:1, for example about 1:1. The invention also relates to a method of orienting strands, or a method of orienting wood strands for application in a board, wherein a mixture as mentioned above of wood strands comprising cement and water with a substantially random orientation is flung away by a rotating interacting device, such as to obtain a substantial longitudinal orientation of the said strands in the air during their displacement, and a subsequent longitudinal orientation of the strands continuously in a longitudinal direction moving moulds.

The invention is also of a method for manufacturing a wood strand cement board and a method for the production of a wood strand cement board wherein the operating procedure comprises at least the following steps:

a) distributing in the moulds a mixture consisting of wood strands, water and cement;

b) pressing said mixture obtained in step a) in the mould;

c) stacking the moulds with the raw material to a stack;

d) pressing the stack of moulds with the raw material, such that the boards acquire a desired thickness and density; and

e) maintaining the required height through the use of a Bottom below the stack and a Top on top of the stack, connected by tie rods during the initial curing stage of the cement. Preferred embodiments are mentioned in the dependent claims.

### BRIEF DESCRIPTION OF THE SEVERAL VIEWS OF THE DRAWINGS

Not Applicable

### DETAILED DESCRIPTION OF THE INVENTION

The invention relates to a mineral bonded wood strand cement (usually Portland cement, magnesite or gypsum) board. The invention also relates to a method of orienting strands and a method for manufacturing a wood strand cement board.

Wood cement boards and fibre cement boards are used worldwide in a large number of varying applications. Advantages of these boards are, amongst others, the durability and the resistance against fire, moisture, rot, fungi and termites and its easy workability re screwability and nailability.

Wood wool cement boards have been known for almost a century. These boards are made of wood wool (in the USA called Excelsior), (usually curled, especially for ceilings) fibres of restricted width, water and cement. These known boards have an open matrix and therefore are of a relatively low density. Initially, these boards were used for insulation purposes and as a base for stuccoed ceilings. Nowadays these boards are also used for decoration purposes and as sound absorbing boards. Such exposed applications are made possible by the introduction of automated machines for the production of these boards. With the development of machines with control systems that control the accurate dosing and mixing of the raw materials, and the very even distribution of the mixture in the moulds and the stacking and pressing of the moulds with the fresh mixture, the production of boards of a constant high quality is attained. With the availability of these machines, it is possible to produce boards of high quality at low costs. In particular by using moulds of plywood (concrete form boards) and a low pressure press, the costs for the equipment of a production line of wood wool cement boards are relatively low.

However, because of their very open matrix structure, wood wool cement boards are unsuitable for structural applications like external wall claddings and as roofing. For, in such cases a closed and water proof layer has to be applied. Moreover, the strength of low density wood wool cement boards is not sufficient for structural applications like for (raised) flooring.

To the present day, applications like external claddings and roofing are amongst others made with corrugated or flat fibre cement boards or shingles. These boards and products have a closed matrix and are waterproof. Optionally, flat fibre cement boards can be provided with a relief in the surface, for example with a texture of slate, brick or imitation wood grain. Until recently, these Fibre Cement Boards were mainly made from cement and asbestos fibres, which were suitable because of their durability and strength. In many countries, asbestos fibres are now replaced by cellulose and synthetic fibres, mainly due to the legislation which forbids the use of asbestos because of the danger for the labour of the manufacturers and the processors of the boards. A disadvantage of the fibre cement boards is, however, that these boards are not as strong and not as durable as the asbestos boards and moreover synthetic fibres and strong cellulose are expensive.

The Dutch patent 1 010 195 describes wood strand cement boards which possess the advantages of wood and fibre cement boards concerning the durability and the resistance against fire, moisture, rot, fungi and termites.

However, these boards have a number of essential disadvantages. One of the disadvantages is that in the compressed upper layer made of cement mortar or another sealing material, hair cracks can appear in the surface, especially in case the cement layer is not supplied with a coating finish such as paint. Another disadvantage is that due to the relatively low density of these boards, of only 800 to 900 kg per m³, the bending strength leaves much to be desired and further the screwability and nailability and screw and nail holding capability of these boards is problematic.

Other problems arise in the processing of such boards, like profiling, applying tongues and grooves and beveling of the edges of the boards. Further, these boards may curve under the influence of a varying moisture content due to being not balanced with identical surfaces.

The invention under consideration aims to provide a wood strand cement board that can annihilate the aforementioned disadvantages.

To this aim the present invention provides a wood strand cement board as indicated in the characterizing portion of claim 1.

Surprisingly, it has been shown that with the features of the present invention the aforementioned disadvantages are nullified quite effectively.

According to the invention, said wood strands have a width of at least 2 mm, preferably at least 3 mm and most preferably at least 6 mm and a width of maximally 12 mm or more, preferably maximally 10 mm, and a thickness of at least 0.15 mm and maximally 1.0 mm, preferably maximally 0.5 mm. The weight ratio of water to wood strands is maximally 1.25:1, preferably maximally 1.20:1, more preferably maximally 1.10:1, for example about 1:1. By using this amount of water in relation to the amount of wood strands, wherein the amount of water determines the amount of cement that can be added, a board is obtained that does not have a cement matrix with wood strands incorporated therein. The cement added is used mainly for binding the wood strands together. Hence, the board according to the invention has an excellent flexibility, bending strength, and workability, for screwing and nailing, for example.

Surprisingly, it has been shown that with the use of wood strands with sharp edges, the edges of the wood strands no longer show at the surfaces of the board. Furthermore, it shows that even when the wood strands are distributed at random, a smooth and almost ridge free surface is obtained after pressing without the use of a coating layer of saw dust and cement as described in the Dutch patent 1 010 195.

Since the boards according to the invention can have a density of more than 900 kg per m³ and up to 1300 kg per m³, preferably minimally 950 kg per m³, more preferably minimally 1000 kg per m³, and maximally 1250 kg per m³, more preferably maximally 1200 kg per m³, still more preferably maximally 1150 kg per m³, it has turned out that the boards have a considerable higher bending strength compared to the known boards as described in the before mentioned Dutch patent, which have a density of only 800 to 900 kg per m³.

Moreover, the boards according to the invention are better nailable and screwable and the screws, staples and nails hold better in the new material.

This higher density of the boards under consideration results in a considerable improvement in relation to the processing of the boards, such as profiling, the application of grooves and beveling of the edges of the boards and for providing (fine grain) embossings.

It is noted that although the board can be painted or stuccoed, there is no need for stuccoing on account of the particularly smooth surface. It has been proven that even without further surface treatment like painting, the boards are wind and weatherproof.

Surprisingly, it has also turned out that the use of long wood strands according to the invention leads to a bending strength of more than double the European CEN Norm set for the high density Cement Bonded Particle Boards of small wood particles, at an approximately 20% lower density and in addition makes the boards considerably cheaper to produce, transport, handle and install.

The boards according to the invention can be provided on one side with an embossing of, for instance, a slate or wood grain texture, which makes them suitable as durable cladding boards or planks on the exterior of a building.

Another important advantage of the boards under consideration is their resistance to fire, moisture, rot and fungi, as well as large numbers of thaw-and-frost cycles. In addition, they are resistant to all weather conditions and the devastating effect of termites.

The boards according to the invention are very durable and can also be applied successfully in tropical countries that are afflicted by hurricanes, rainstorms and earthquakes like in Central America (Honduras, Guatemala, El Salvador, Nicaragua).

According to a further aspect, the invention relates to a method of orienting wood strands for application in a board according to the present invention, wherein a mixture as mentioned in claim 1 of wood strands comprising cement and water with a substantially random orientation is flung away by a rotating interacting device, such as to obtain a longitudinal orientation of the said strands in the air during their displacement, and a subsequent longitudinal orientation of the strands in a continuous moving moulds collection tray. Such device preferably is comprised of a rotating drum with spikes that interact with the strands. Good orientation results are obtained when the strands are flung away about 1-2 meters. It has shown that an oriented wood strand yields a higher bending strength and flexibility of the board and improved results with respect to a reduced expansion of the board, for example due to moisture, rain and other wet weather circumstances. A longitudinal orientation of the strands yields an expansion of the board that is substantially directed in the transversal direction of the thickness, less in the direction of the width, and far less in the important longitudinal direction of the boards and planks.

Furthermore, the invention relates to the method for the manufacturing of wood strand cement boards, which is characterized by the following steps:

a) distribution into moulds of a mixture consisting of wood strands, water with additives, and cement (usually Portland cement, magnesite or gypsum);

b) pressing said mixture obtained in step a) in the moulds;

c) stacking of the moulds with raw material up to the desired height;

d) pressing of the stack of moulds with raw material, in order to achieve the desired density of the boards; and

e) maintaining of this height through a connection of a so-called Bottom which lies beneath the stack, with a Top, which lies on top of the stack, using tie rods during the initial stage of curing of the cement.

The additives that are added to the water in step a) of the manufacturing method, are known to a man skilled in the art.

Wood strands with a width of preferably at least 2 mm, more preferably at least 3 mm and most preferably at least 6 mm and a width of maximally 12 mm or more, more preferably maximally 10 mm, and most preferably maximally 9 mm; and a thickness of 0.15-1.0 mm, preferably 0.15-0.3 mm are used. The length of the fibers should preferably be at least 250 mm, but depends on the machines producing these strands and the quality of the wood used.

It is particularly advantageous to use wood strands with pointed edges, especially if angles of less than 120° are provided on the strands, especially on the surfaces of the board to obtain smooth surfaces.

Besides, for the production of the boards both moulds of plywood as cauls of steel or hard plastic can be used.

For the production of Wood Strand Cement Boards with a relief surface according to the invention, a separate board with a counter-profile is placed in the mould respectively the top of the mould itself is provided with a counter-profile.

For certain reliefs it is possible when directly onto the counter-relief board a mixture of wood strands, water and cement is distributed, which subsequently is being pressed to achieve the wanted relief, without using an additional sealing layer of cement possibly mixed with short fibres such as saw dust.

According to the invention, at least part of the wood strands is oriented more longitudinally than transversely to the length of the board during the application and distribution of the mixture of wood strands, water and cement. Due to such orientation of the wood strands lengthwise in relation to the board, the strength, the flexibility and the elasticity of the board will increase in longitudinal direction considerably and the linear stability in this direction due to variations in moisture content is much higher in comparison to the two other directions (width and thickness). This is due to the fact that wood shrinks and expands due to variations in moisture content, mainly in thickness and hardly in length.

In case the boards are made with sufficient thickness, they can be sawed into laths or strips of timber, or planks. I beam and other profiles can be assembled from strips, laths or planks obtained from the invention. Such laths can be glued together to I beams. Those laths, planks and beams are, because of their strength and stability and their resistance to fire and termites, very suitable for applications in construction work, in particular in countries with many wooden buildings, such as the United States, Scandinavia, Canada, and so on. Such planks can also be favorably used for durable exterior claddings of buildings.

As a matter of fact, corrugated and trapezium shaped profiles, for example roof and wall boards, may be produced as well according to the present invention.

A further improved product is obtained when the surface of the board is provided with a closed cover layer of a composition used for totally closing said surface of the board. By this measure, also a further increased weather resistance is obtained. Furthermore, the surface of the board can be easily provided with some deeper relief, like a brick structure or the like. Also, without such cover layer, a structure can be applied, but the depth of any relief is restricted due to the presence of the strands.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A wood strand cement board, manufactured from a mixture consisting essentially of:
wood strands or a similar fiber material;
a suitable binder like cement; and
water;
which mixture is cured to form a board with a practically entirely closed surface, wherein said wood strands have a width of at least 2 mm, a width of maximally 12 mm, and a thickness of at least 0.15 mm and maximally 1 mm and wherein the weight ratio of water to wood strands is maximally 1.25:1.

2. A board as described in claim 1, wherein the edges of the strands are pointed.

3. A board as described in claim 1, wherein the edges of the strands are sharp with angles equal to or less than about 120°.

4. A board as described in claim 1, wherein at least 50% of the wood strands is oriented more longitudinally than transversely to the length of the board, preferably at least 60%, more preferably at least 70%, still more preferably at least 75%.

5. A method of orienting wood strands for application in a board according to claim 1, wherein a mixture as mentioned in claim 1 of wood strands comprising cement and water with a substantially random orientation is flung away by a rotating interacting device, such as to obtain a substantial longitudinal orientation of the said strands in the air during their displacement, and a subsequent substantial longitudinal orientation of the strands continuously in, in a longitudinal direction moving moulds.

6. A board as described in claim 1, wherein said wood strands have a width of at least 3 mm.

7. A board as described in claim 6, wherein said wood strands have a width of at least 6 mm.

8. A board as described in claim 1, wherein said wood strands have a width of maximally 10 mm.

9. A board as described in claim 1, wherein said wood strands have a thickness of maximally 0.5 mm.

10. A board as described in claim 1, wherein said weight ratio of water to wood strands is maximally 1.10:1.

11. A method for the production of a wood strand cement board, wherein the operating procedure comprises the following steps:
a) distributing in the moulds a mixture consisting essentially of wood strands, water and cement;
b) pressing said mixture obtained in step a) in the mould;
c) stacking the moulds with the raw material to a stack;
d) pressing the stack of moulds with the raw material, such that the boards acquire a desired thickness and density; and
e) maintaining the required height through the use of a bottom below the stack and a top on top of the stack, connected by tie rods during the initial curing stage of the cement.

12. A method as described in claim 11, wherein wood strands are used with a width of 2-12 mm.

13. A method as described in claim 11, wherein wood strands are used with a width of greater than 12 mm.

14. A method as described in claim 12, wherein wood strands are used with a width of 3-10 mm.

15. A method as described in claim 11, wherein wood strands are used with a thickness of 0.15-1.0 mm.

16. A method as described in claim 15, wherein wood strands are used with a thickness of 0.15-0.5 mm.

17. A method as described in claim 11, wherein wood strands are used with pointed edges.

18. A method as described in claim 17, wherein the edges of the strands are sharp with angles equal to or less than 120°.

19. A method as described in claim 11, wherein at the bottom a relief is situated with a counter-profile, or respectively the top of the mould has a counter-profile.

20. A method as described in claim 19, wherein onto the relief board a mixture of wood strand, water and cement is distributed, which subsequently is being pressed to yield a profile without the additional use of a mixture of water, fibers and cement.

21. A method as described in claim 11, wherein during the application of the mixture consisting of mainly wood strands, water and cement, at least a majority of the wood strands is oriented more in the longitudinal direction than in the transversal direction in relation to the length of the board.

22. Beams, strips, lath or planks sawn from relatively thick boards as described in claim 1.

23. I beam and other profiles assembled from strips, lath or planks obtained according to claim 22.

24. A board with corrugated or trapezium shaped profiles, obtained with a method according to claim 22.

25. A board according to claim 1, wherein said board comprises at one of its surfaces a closed cover layer comprising a mixture for totally closing said surface of the board.
